(19) United States
(12) Patent Application Publication
(10) Pub. No.: US 2022/0404921 A1
(43) Pub. Date: Dec. 22, 2022

(54) CLICKPAD LOCKING ASSEMBLIES

(71) Applicant: Hewlett-Packard Development Company, L.P., Spring, TX (US)

(72) Inventors: Tony Seokhwa Moon, Spring, TX (US); Derek Kyle Joseph Kanas, Spring, TX (US); Hung Sung Pan, Taipei City (TW)

(73) Assignee: Hewlett-Packard Development Company, L.P., Spring, TX (US)

(21) Appl. No.: 17/639,449

(22) PCT Filed: Nov. 11, 2019
(86) PCT No.: PCT/US2019/060754

§ 371 Date: Mar. 1, 2022

(51) Int. Cl. G06F 3/0354; G06F 1/16

(52) U.S. Cl. CPC G06F 3/03547; G06F 1/169

(57) ABSTRACT

An example electronic device includes a housing, a clickpad coupled to the housing, and a switch disposed within the housing, under the clickpad. Depression of the clickpad is to actuate the switch. In addition, the electronic device includes a locking assembly including an obstruction member disposed under the clickpad. The obstruction member is to translate the obstruction member under the clickpad from a first location to a second location to disable an actuation of the switch.

### BACKGROUND

Electronic devices may utilize a user input device known as a clickpad or touchpad (collectively referred to herein as a “clickpad”). In some circumstances, the clickpad may be utilized along with other user input devices, such as a keyboard. The clickpad may be touch sensitive so that a user may use their finger or a separate device (e.g., a stylus) to make touch inputs on the clickpad for making an input on the associated electronic device. In addition, depression of the clickpad may provide additional inputs on the electronic device.

### BRIEF DESCRIPTION OF THE DRAWINGS

Various examples will be described below referring to the following figures:

FIG. 1 is a perspective view of an example electronic device including a clickpad and locking assembly according to some examples;

FIG. 2 is an underside view of the clickpad and locking assembly of the electronic device of FIG. 1, in which an obstruction member of the locking assembly is in a first position according to some examples;

FIG. 3 is a cross-sectional view taken along section A-A in FIG. 2 according to some examples;

FIG. 4 is an underside view of the clickpad and locking assembly of the electronic device of FIG. 1, in which the obstruction member of the locking assembly is in a second position according to some examples;

FIG. 5 is a cross-sectional view taken along section B-B in FIG. 4 according to some examples;

FIG. 6 is a front side view of the clickpad and locking assembly of the electronic device of FIG. 1, including a pair of tracks for guiding translation of the obstruction member according to some examples;

FIG. 7 is an underside view of the clickpad and locking assembly of the electronic device of FIG. 1, including a biasing assembly for biasing a translation of the obstruction member according to some examples; and

FIGS. 8 and 9 are cross-sectional views of example clickpad and locking assemblies for use within the electronic device of FIG. 1 according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis, while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

As previously described, a clickpad may be utilized by a user to make various inputs on an electronic device. Inputs may be received by the clickpad either by touch events on a touch sensitive surface of the clickpad, or in some circumstances by pushing or depressing the clickpad so as to actuate a switch or plurality of switches disposed thereunder. In some instances, a user utilizing the clickpad to make touch inputs (e.g., with the user's finger or a stylus) may inadvertently depress the clickpad and thereby actuate the switch or switches disposed thereunder. Since a switch actuation and touch inputs may provide different inputs on the associated electronic device as previously described, a user may find this inadvertent switch actuation to be undesirable. Moreover, to avoid such an inadvertent depression of the clickpad and thereby switch actuation, a user may apply a minimal amount of pressure to the clickpad when making touch inputs, which again may contribute to an unsatisfying user experience (e.g., such as in the case of making touch inputs via a stylus or other such device).

Accordingly, examples disclosed herein include locking assemblies for a clickpad that may be utilized to selectively disable actuation of a switch or switches disposed under a clickpad. In some examples, the locking assemblies may also prevent or restrict depression of the clickpad itself. Thus, as will be described in more detail below, the use of the clickpad locking assemblies disclosed herein, inadvertent switch actuation of a clickpad may be reduced, thereby increasing a user's satisfaction.

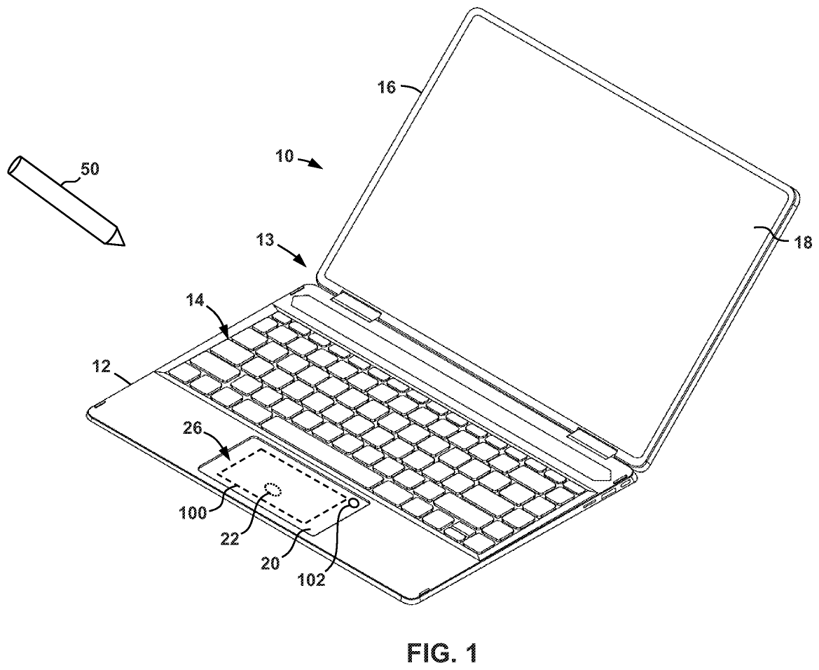

Referring now to FIG. 1, an electronic device 10 according to some examples is shown. As used herein, the term “electronic device,” refers to a device that is to carry out machine readable instructions, and may include internal components, such as, processors, power sources, memory devices, etc. In this example, electronic device 10 is a laptop computer that includes a first housing member 12 rotatably coupled to a second housing member 16 at a hinge 13. The first housing member 12 includes a plurality of user input devices, such as, for example, a keyboard 14, and a clickpad 20. The second housing member 16 includes a display 18 (e.g., a liquid crystal display (LCD), a plasma display, organic light emitting diode (OLED) display, etc.) that is to generate images for viewing by a user (not shown) of the electronic device 10.

In this example, clickpad 20 is touch-sensitive, so that electronic device 10 may sense or determine touch inputs on clickpad 20 during operation. A user may provide touch inputs to clickpad 20 via any suitable device or member, such as, for instance, a finger (not shown) and/or a stylus 50. Clickpad 20 may utilize any suitable touch-sensitive technology to register or detect touch inputs. For instance, in some examples clickpad 20 may include a resistive touch input assembly, a capacity touch input assembly, a surface acoustic wave touch input assembly, an infrared touch input assembly, etc.

In addition, clickpad 20 may also include or be coupled to a switch 22 disposed underneath clickpad 20. During operations, a user may depress clickpad 20 into housing first housing member 12 by applying a sufficient level of pressure or force to a first or top surface or side 26 of clickpad 20. The depression of clickpad 20 into first housing member 12 may eventually cause an actuation of the switch 22 thereby providing an input to electronic device 10 (that is, an input that is separate and distinct from the touch inputs that may be detected on clickpad 20 and previously described above).

Referring still to FIG. 1, a locking assembly is coupled to clickpad 20 and generally disposed within first housing member 12. As will be described in more detail below, the locking assembly 100 is to selectively disable actuation of switch 22 and may prevent (or restrict) the depression of clickpad 20 into first housing member 12 during operations. In this example, a selection button or switch 102 is disposed on clickpad 20 (but may be disposed in any suitable location on electronic device 10 in other examples). A user may actuate switch 102 so as to selectively actuate the locking assembly 100 to disable actuation of switch 22 and/or prevent (or restrict) depression of clickpad 20 during operations. In some examples, switch 102 may include an indicator light to communicate to the user whether locking assembly 100 is actuated or not during use of the electronic device 10. Further details of the examples of locking assembly 100 are now described below.

Referring now to FIGS. 1-3, locking assembly 100 is disposed under clickpad 20 within the first housing member 12 of electronic device 10 (see e.g., FIG. 1). In particular, clickpad 20 includes a first or top side 26 and a second or bottom side 24 opposite top side 26. Generally speaking, bottom side 24 may face into the first housing member 12, and top side 26 may face outward or away from first housing member 12. During operations, a user may interact with top side 26 to make touch inputs (e.g., with a finger or stylus 50), and to depress clickpad 20 to actuate switch 22.

A substrate 30 may be disposed within first housing member 12, under the bottom side 24 of clickpad 20. The substrate 30 may comprise any suitable member or surface, such as for instance, a printed circuit board (PCB) for mounting electronic components for use in operating clickpad 20 and/or other features and components within electronic device 10. For instance, substrate 30 may support electronic components for providing the touch-sensitivity of clickpad 20 and/or the electrical signaling corresponding with an actuation of switch 22. In some examples, substrate 30 may comprise a surface or structure forming the first housing member 12. Regardless of the components or structure forming substrate 30 in various examples, substrate 30 comprises a surface 32 that opposes the bottom side 24 of clickpad 20.

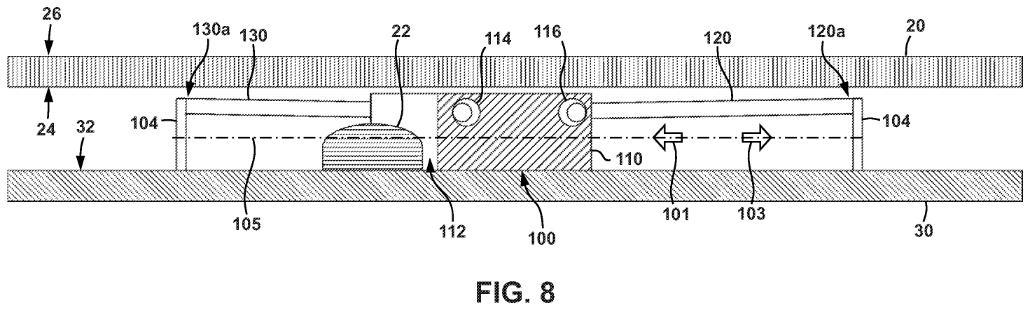

Switch 22 may comprise any suitable switching mechanism (e.g., button) that may be actuated to make an input to electronic device 10. For instance, switch 22 may comprise a so-called snap dome switch that may provide a haptic click or pop when depressed. In this example, switch 22 is mounted to bottom side 24 of clickpad 20; however, switch 22 may be mounted to other surfaces within first housing member 12 in other examples as described in more detail below (see e.g., FIG. 8). During operations, a user may depress clickpad 20 by pressing inward on top side 26 (i.e., inward into first housing member 12) to compress the switch 22 between the clickpad 20 and surface 32, and thereby actuate the switch 22.

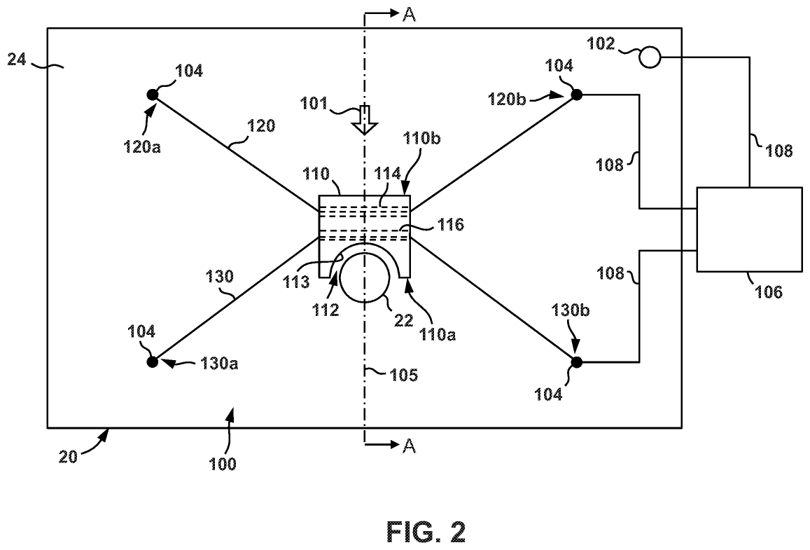

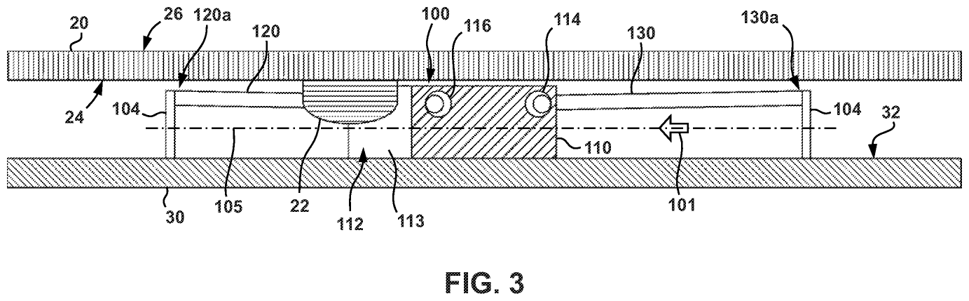

Referring specifically now to FIGS. 2 and 3, locking assembly 100 comprises an obstruction member 110, a first cable 120, and a second cable 130 all disposed between the bottom side 24 of clickpad 20 and surface 32 of substrate 30. As will be described in more detail below, during operations, the cables 120, 130 may be selectively contracted so as to translate the obstruction member 110 along an axis of translation 105 extending between bottom side 24 of clickpad 20 and surface 32 of substrate 30 so as to selectively enable and disable compression and actuation of the switch 22 during operations.

Obstruction member 110 comprises a first or front end 110a, and a second or back end 110b opposite front end 110a. In addition, obstruction member 110 comprises a recess 112 extending axially into obstruction member 110 from front end 110a. In this example, recess 112 comprises a cylindrical recess that includes a concave cylindrical wall 113 having a radius of curvature (not shown) extending perpendicularly or orthogonally to the axis of translation 105. A first aperture or recess 114 and a second aperture or recess 116 extend through obstruction member 110 in a direction that is radial or perpendicular to the axis of translation 105. The first aperture 114 may be axially positioned between the back end 110b and the second aperture 116 with respect to the axis of translation 105, and the second aperture 116 may be axially positioned between the front end 110a and the first aperture 114 with respect to the axis of translation 105.

First cable 120 includes a first end 120a and a second end 120b opposite first end 120a. Second cable 130 includes a first end 130a and a second end 130b opposite first end 130a. The ends 120a, 120b, 130a, 130b of cables 120, 130 are secured to corresponding mounting structures 104 disposed under clickpad 20. In some examples, the mounting structures 104 may comprise posts, or other suitable engagement points (e.g., crimp mounts), that are mounted to the bottom surface 24 of clickpad 20, the surface 32 of substrate 30, or both. First cable 120 is routed through the first aperture 114 in obstruction member 110 between ends 120a, 120b. Second cable 130 is routed through second aperture 116 in obstruction member 110 between ends 130a, 130b.

In some examples (e.g., such as the example of FIGS. 2 and 3), the cables 120, 130 comprise memory materials, such as, for instance shape memory alloys. Potential examples of shape memory alloys forming the cables 120, 130 include, for instance, copper-aluminum alloy, nickel-titanium alloy, or a combination thereof. Thus, the cables 120, 130 may be deformed into a predetermined shape or length by transferring heat to (or from) the cables 120, 130. In some examples, the cables 120 and 130 may each have a length between the ends 120a, 120b and 130a, 130b, respectively, that may be varied or changed based on the temperature of the cables 120, 130. In particular, in some examples, the lengths of the cables 120, 130 may be shortened by increasing a temperature of the cables 120, 130 above a threshold. In some examples, the cables 120, 130 may be energized with electric current, so that the electrical resistivity of the cables 120, 130 may cause an increase in their temperature so as to selectively shorten the length thereof during operations.

As best shown in FIG. 2, an electrical switch assembly 106 is coupled to the cables 120, 130 and the switch 102 (see also FIG. 1) that is to selectively route electric current to the cables 120, 130 so as to contract the cables 120, 130 during operations. In particular, the switch assembly 106 may be coupled to the switch 102, and the cables 120, 130 via a plurality of conductive paths 108. In some examples, the switch assembly 106 may be coupled to the cables 120, 130 via the mounting structures 104. Conductive paths 108 may comprise any suitable electrically conductive path, member, trace, or combination thereof (e.g., wire, conductive contact, etc.). In some examples, some (or all) of the conductive paths 108 may comprise (e.g., partially or wholly) a wireless connection. Switch assembly 106 is coupled to (or includes) an electrical power source 107 that may be a dedicated electrical power source for locking assembly 100 or a separate power source that may be utilized to operate other components (e.g., electronic device 10). For instance, in some examples electrical power source 107 may comprise a battery, capacitor, a wall plug, and/or any other suitable source of electric power.

Referring now to FIGS. 2-5, during operations a user may touch or depress the switch 102 to selectively disable or enable the actuation of the switch 22 as previously described above. In particular, referring specifically to FIGS. 2 and 3, a user may select or actuate the switch 102 to disable actuation of the switch 22. Upon such an actuation of the switch 102, switch assembly 106 may pass electric current from the power source 107 to the second cable 130. Energizing the second cable 130 in turn increases a temperature of the cable 130 so as to cause the cable 130 to contract and shorten its length as previously described above.

As the cable 130 is contracted, the obstruction member 110 is translated in a first direction 101 along the axis of translation 105, toward a first location that is proximate and/or about the switch 22. Thus, the first direction 101 may be generally directed toward the switch 22 along the axis of translation 105. As the obstruction member 110 translates toward switch 22, the switch 22 is received (e.g., partially received) within recess 112, and the obstruction member 110 is disposed between the bottom side 24 of clickpad 20 and the surface 32 of substrate 30 about the switch 22. As a result, once obstruction member 110 is disposed in the position or location of FIGS. 2 and 3, the recess 112 partially encompasses the switch 22 and depression of the clickpad 20 toward substrate 30 in a region about the switch 22 may be restricted (or totally prevented) via engagement of the obstruction member 110 between the bottom side 24 of clickpad 20 and the surface 32 of substrate 30. Accordingly, when obstruction member 110 is in the position of FIGS. 2 and 3, the obstruction member 110 may be wedged between the clickpad 20 and substrate 30 about the switch 22 to restrict (or prevent) depression of the clickpad 20 and actuation of the switch 22. As used herein, the term “wedge” refers to the situation where one member (e.g., the obstruction member 110) is disposed and/or engaged between two other members (e.g., the clickpad 20 and the substrate 30). For avoidance of doubt, as used herein the term “wedge” should not be read or interpreted as requiring any particular structure or shape, such as, for instance, a tapering edge or angled surface(s). Therefore, the position of the obstruction member 110 shown in FIGS. 2 and 3 and described above may be referred to herein as a “locked position.”

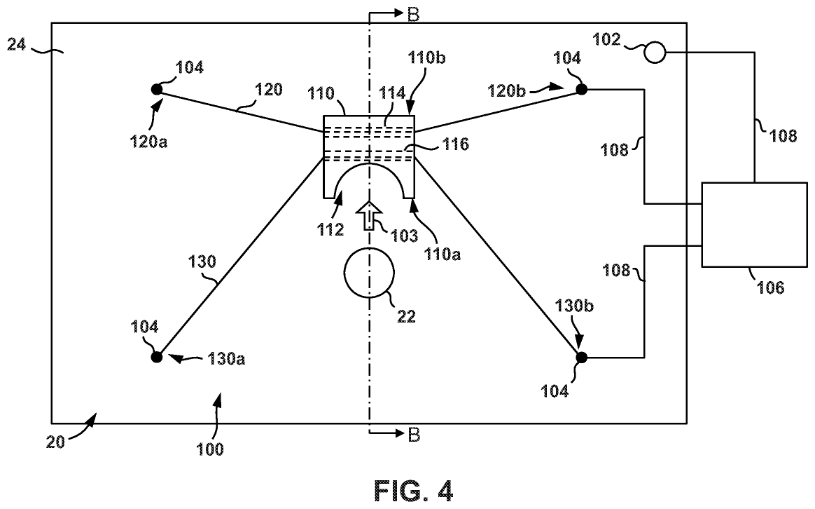

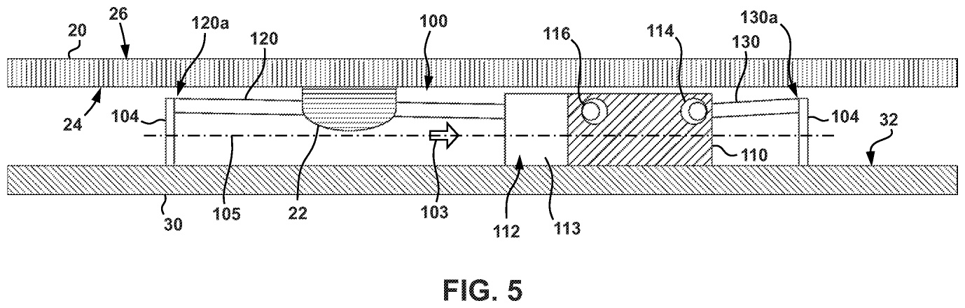

Referring specifically to FIGS. 4 and 5, a user may also select or actuate the switch 102 to enable actuation of the switch 22. Upon such an actuation of the switch 102, switch assembly 106 may pass electric current from the power source 107 to the first cable 120. Energizing the first cable 120 in turn increases a temperature of the cable 120 so as to cause the cable 120 to contract and shorten its length as previously described above.

As the cable 120 is contracted, the obstruction member 110 is translated in a second direction 103 along the axis of translation 105, toward a second location that is disposed away or distal from the switch 22. The second direction 103 may be opposite the first direction 101 (see e.g., FIGS. 2 and 3), and thus, the second direction 103 may be generally directed away from the switch 22 along the axis of translation 105. As the obstruction member 110 translates away from switch 22, the clickpad 20 may more freely move toward and away from the substrate 30 at the switch 22. That is, when the obstruction member 110 is spaced from the switch 22, such as shown in FIGS. 3 and 4, the clickpad 20 may be depressed in the region surrounding the switch 22 (e.g., bent, rotated, etc.) so that the switch 22 may be compressed between the clickpad 20 and substrate 30 (e.g., between bottom side 24 and surface 32 of substrate 30) and thereby actuated. Accordingly, when the obstruction member 110 is translated away from the switch 22 as shown in FIGS. 3 and 4 (e.g., via contraction of the first cable 120 as previously described), actuation of the switch 22 may generally be enabled. As a result, the position of the obstruction member 110 shown in FIGS. 4 and 5 and described above may be referred to herein as an “unlocked position.”

In some examples, the selective contraction of cables 120, 130 may be triggered via other mechanisms or methods either in lieu of or in addition to actuation of switch 102. For instance, in some examples the cables 120, 130 may be selectively contracted to disable or enable actuation of switch 22 in response to a user selection made within a menu displayed on display 18 of electronic device 10 (see e.g., FIG. 1), in response to a voice command and/or physical gesture provided by the user and sensed/detected by the electronic device 10, etc. Thus, contraction of the cables 120, 130 and actuation of obstruction member 110 between the locked and unlocked positions as described above may be initiated by a number of different methods and/or mechanisms, and the actuation of switch 102 is merely one possible example.

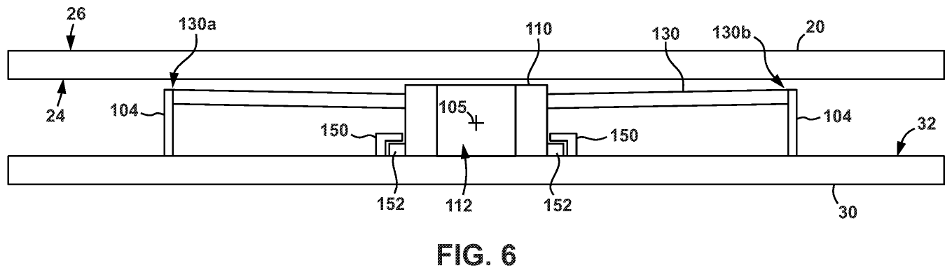

Referring now to FIG. 6, in some examples, the locking assembly 100 may comprise one or a pair of tracks 150 that are to guide the translation of obstruction member 110 along the axis of translation 105 during operations. In particular, in some examples (e.g., such as the example of FIG. 6), the obstruction member 110 may include a pair of extensions 152 that fit within corresponding ones of the tracks 150, and the tracks 150 extend in an axial direction along the axis of translation 105. Thus, during operations, as the cables 120, 130 are contracted so as to force the translation of the obstruction member 110 under clickpad 20, the tracks 150 may help to ensure that the translation of the obstruction member 110 is along the axis of translation 105 (e.g., in the directions 101, 103 shown in FIGS. 2-5).

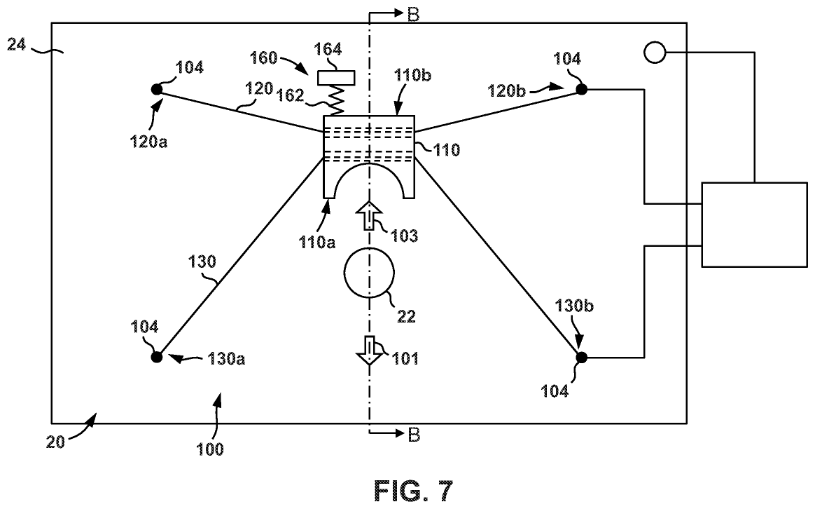

Referring now to FIG. 7, in some examples, the locking assembly 100 may comprise a biasing assembly 160 to bias the obstruction member 110 along the axis of translation 105, away from the locked position of FIGS. 2 and 3 and toward the unlocked position of FIGS. 4 and 5. In particular, biasing assembly 160 comprises a biasing member 162 that is coupled between the back end 110b and a support structure 164 disposed under clickpad 20. The biasing member 162 may generally bias obstruction member 110 in the second direction 103 along the axis of translation 105 so as to bias the obstruction member 110 away from the locked position of FIGS. 2 and 3. Thus, the during operations, the biasing assembly 160 may help to ensure that the actuation of switch 22 is enabled even when electric current is not flowing to either of the cables 120, 130.

In some examples, the locking assembly 100 may include one of the cables 120, 130, and may utilize the biasing force supplied by the biasing assembly 160 to drive translation of the obstruction member 110 in the second direction 103. For instance, in the example of FIG. 7, the first cable 120 may be omitted so that actuation of the switch 102 may toggle electric current on and off to the second cable 130 so as to translate obstruction member 110 against the bias provided by biasing member 162 toward the switch 22 (e.g., in the first direction 101). In other examples, a biasing assembly (e.g., biasing assembly 160) may be coupled to the obstruction member 110 so as to bias the obstruction member 110 in the first direction 101, toward the switch 22. In these examples, the second cable 130 may be omitted, and the actuation of the switch 102 may toggle electric current on and off to the first cable 120 so as to translate obstruction member 110 against the bias provided by biasing member 162 away from the switch 22 (e.g., in the second direction 103).

As previously described above, in some examples, the switch 22 may be disposed along other surfaces or components within the first housing member 12 (see e.g., FIG. 1) other than the bottom side 24 of clickpad 20. For instance, referring now to FIG. 8, in some examples, switch 22 may be disposed along the surface 32 of substrate 30. However, in these examples, the depression of clickpad 20 may again cause compression of the switch 22 between the clickpad 20 and substrate 30 (e.g., between the bottom side 24 and surface 32) so as to cause actuation of the switch 22 as described above. Thus, in these examples, the actuation of the obstruction member 110 in the first direction 101 and second direction 103 along the axis of translation 105 (e.g., by the selective contraction of cables 120, 130 and/or a bias provided by biasing assembly 160, etc.) may cause actuation of the switch 22 to be disabled and enabled, respectively, in the manner described above.

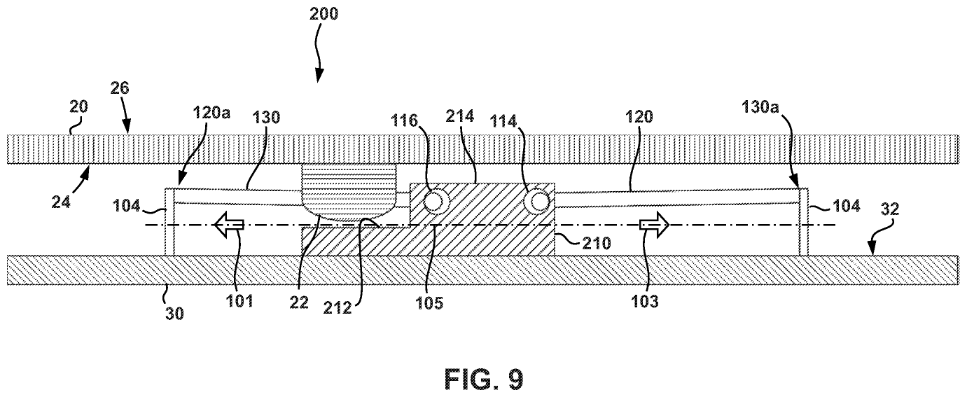

Referring now to FIG. 9, another example of a locking assembly 200 for selectively disabling actuation of the switch 22 is shown. Locking assembly 200 shares many components with the locking assembly 100, previously described above. Thus, the components of locking assembly 200 that are shared with locking assembly 100 are identified with the same reference numerals, and the description below will focus on the features and components of locking assembly 200 that are different from locking assembly 100.

Generally speaking, locking assembly 200 includes an obstruction member 210 in place of obstruction member 110. In addition, obstruction member 210 includes a switch engagement surface 212 and a clickpad engagement surface 214. In this example, the switch engagement surface 212 and clickpad engagement surface 214 are planar surfaces that generally extend axially along the axis of translation 105. However, the switch engagement surface 212 is offset from the clickpad engagement surface 214 (e.g., in a radial direction with respect to axis of translation 105). Specifically, the clickpad engagement surface 214 is generally closer to the clickpad 20 than the switch engagement surface 212. In some examples, the switch engagement surface 212 may be angled relative to the axis of translation 105. In addition, in some examples, the switch engagement surface 212 and/or the clickpad engagement surface 214 may be curved (e.g., concave, convex, etc.). Obstruction member 210 also includes first and second apertures 114 and 116, respectively, that receive first and second cables 120 and 130, respectively, as previously described above for obstruction member 110.

During operations, cables 120, 130 may be selectively contracted so as to translate the obstruction member 210 along the axis of translation 105 in the directions 103, 101, respectively, as generally described above. In this example, the contraction of the second cable 130 may translate the obstruction member 210 in the first direction 101 along axis of translation 105 toward a location that is generally aligned with switch 22 (and that is depicted in FIG. 9). In particular, when the obstruction member 210 is translated along the first direction 101, the switch engagement surface 212 may be aligned with switch 22 (e.g., the switch 22 and switch engagement surface 212 may be generally aligned or overlapped in a radial direction with respect to axis of translation 105). Thus, when obstruction member 210 is in the position shown in FIG. 9, a depression of the clickpad 20 (e.g., via pressure applied by the user's finger or other implement to the top side 26 of clickpad 20) may cause the switch 22 to be compressed against switch engagement surface 212 so as to enable actuation of the switch 22.

Conversely, during operations, the first cable 120 may be contracted so as to translate the obstruction member 210 in the second direction 103 along the axis of translation 105. In particular, when the obstruction member 210 is translated along the second direction 103, the obstruction member 210 may be generally misaligned with and axially spaced from the switch 22 along the axis of translation 105. Thus, when obstruction member 210 is translated in the second direction 103 so as to be misaligned with the switch 22, a depression of the clickpad 20 (e.g., via pressure applied by the user's finger or other implement to the top or first side 26 of clickpad 20) may not result in a compression and thereby actuation of the switch 22. Specifically, in some examples (e.g., such as the example of FIG. 9) the switch 22 may be sufficiently spaced from the surface 32 of substrate 30 (e.g., in a radial direction with respect to axis of translation 105) so that depression of the clickpad 20 may not result in any or a sufficient amount of compression of the switch 22, to cause an actuation of the switch 22 as described above. In some examples, the clickpad 20 may engage with the clickpad engagement surface 214 on obstruction member 210 so as to restrict or prevent movement of the clickpad 20 and thereby possible compression and actuation of switch 22 during operations. Accordingly, when the obstruction member 210 is translated in the second direction 103 along the axis of translation 105, the actuation of the switch 22 may be generally disabled.

During the above-described operations, the cables 120, 130 may be selectively contracted via actuation of switch 102 (see e.g., FIG. 1). However, any suitable actuation method may be used in various examples as previously described above.

The examples disclosed herein have included locking assemblies (e.g., locking assemblies 100, 200) for a clickpad that are to selectively disable actuation of a switch or switches disposed under a clickpad and, in some examples, to prevent or restrict the depression of the clickpad. Thus, as previously described above, through use of the clickpad locking assemblies disclosed herein, inadvertent switch action of a clickpad may be reduced or entirely avoided, thereby increasing a user's satisfaction. In some circumstances, the reduction or avoidance of inadvertent clickpad depressions (and the corresponding switch actuations) may allow a clickpad surface to generally be enlarged, thereby further increasing the possible uses of a clickpad (e.g., such as a writing surface for a stylus or other instrument) during operations.

While some examples described herein have included locking assemblies for clickpads disposed on an electronic device (e.g., clickpad 20 disposed on electronic device 10), it should be appreciated that other examples may include locking assemblies (e.g., locking assemblies 100, 200, etc.) for use on clickpads that are not integrated within an electronic device. For instance, in some examples, the example locking assemblies described herein may be used on a stand-along clickpad and/or a clickpad incorporated within a separate keyboard device.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a housing;
a clickpad coupled to the housing;
a switch disposed within the housing, under the clickpad, wherein depression of the clickpad is to actuate the switch; and
a locking assembly comprising an obstruction member disposed under the clickpad, wherein the obstruction member comprises a recess, wherein the locking assembly is to translate the obstruction member under the clickpad from a first location to a second location to disable an actuation of the switch via the recess, and wherein the recess is to partially encompass the switch when the obstruction member is at the second location.

2. The electronic device of claim 1, wherein the locking assembly comprises a first cable coupled to the obstruction member, wherein the locking assembly is to contract the first cable to translate the obstruction member along the clickpad from the first location to the second location.

3. The electronic device of claim 2, wherein the locking assembly comprises a second cable coupled to the obstruction member, wherein the locking assembly is to contract the second cable to translate the obstruction member along the clickpad from the second location to the first location.

4. The electronic device of claim 3, wherein the locking assembly is to contract the first cable and the second cable by energizing the first cable and the second cable with electric current.

5. The electronic device of claim 1, wherein the locking assembly comprises a biasing member to bias the obstruction member away from the switch.

6. The electronic device of claim 1, wherein the locking assembly comprises a track disposed within the housing, wherein the locking assembly is to translate the obstruction member along the track.

7. The electronic device of claim 1, wherein the locking assembly is to translate the obstruction member toward the switch to disable actuation of the switch.

8. An electronic device, comprising:
a housing;
a clickpad coupled to the housing;
a switch disposed within the housing, under the clickpad, wherein depression of the clickpad is to actuate the switch;
a locking assembly coupled to the clickpad and comprising:
an obstruction member disposed within the housing, under the clickpad, wherein the obstruction member comprises a recess; and
wherein the locking assembly is to translate the obstruction member to a locked position to disable an actuation of the switch, wherein the recess is to partially encompass the switch when the obstruction member is in the locked position.

9. The electronic device of claim 8, wherein the locking assembly comprises a cable, and wherein the locking assembly is to contract the cable to translate the obstruction member to the locked position.

10. The electronic device of claim 9, wherein the cable comprises a shape memory alloy.

11. The electronic device of claim 8, wherein the locking assembly comprises a biasing member to bias the obstruction member away from the locked position.

12. An electronic device, comprising:
a housing;
a clickpad coupled to the housing;
a surface disposed within the housing, under the clickpad;
a switch disposed within the housing between the surface and the clickpad, wherein depression of the clickpad into the housing is to compress the switch between the clickpad and the surface to actuate the switch; and
a locking assembly coupled to the clickpad and comprising an obstruction member, wherein the locking assembly is to translate the obstruction member under the clickpad to a locked position, whereby the obstruction member is to wedge between the clickpad and the surface to disable actuation of the switch.

13. The electronic device of claim 12, wherein the locking assembly comprises a first cable, wherein the locking assembly is to contract the first cable to translate the obstruction member to the locked position.

14. The electronic device of claim 13, wherein the locking assembly comprises a second cable, wherein the locking assembly is to contract the second cable to translate the obstruction member away from the locked position.

15. The electronic device of claim 13, wherein the locking assembly comprises a biasing member to bias the obstruction member away from the locked position.
